(19) United States
(12) Patent Application Publication
(10) Pub. No.: US 2024/0364193 A1
(43) Pub. Date: Oct. 31, 2024

(54) METHOD FOR MANUFACTURING ROTOR

(71) Applicant: TOYOTA BOSHOKU KABUSHIKI KAISHA, Aichi-ken (JP)

(72) Inventors: Makoto KITAHARA, Toyota-shi (JP); Masaki SUGIYAMA, Okazaki-shi (JP)

(73) Assignee: TOYOTA BOSHOKU KABUSHIKI KAISHA, Aichi-ken (JP)

(21) Appl. No.: 18/641,567

(22) Filed: Apr. 22, 2024

(30) Foreign Application Priority Data
Apr. 25, 2023 (JP) 2023-071634

(51) Int. Cl. H02K 15/03; H02K 1/276

(52) U.S. Cl. CPC H02K 15/03; H02K 1/276

(57) ABSTRACT

A core is arranged to contact a surface of a support plate on one side in a thickness direction. The support plate, which contacts the core, is arranged between a first die and a second die in an opened state such that a surface of the support plate that is opposite to the core contacts the first die, and a gate plate is arranged between the core and the second die. When the first die and the second die are clamped, a thermoplastic is injected from a nozzle into a housing hole, which accommodates a magnet, through a passage formed by the second die and the gate plate. The magnet is fixed to the core with the thermoplastic injected into the housing hole. With the first die heated, the thermoplastic is injected from the nozzle into the housing hole through the passage.

### BACKGROUND

### 1. Field

The present disclosure relates to a method for manufacturing a rotor.

### 2. Description of Related Art

The rotor of an interior permanent magnet motor includes a core formed by stacking iron core pieces in a thickness direction. The core includes housing holes extending through the core in a stacking direction of the iron core pieces. Each of the housing holes accommodates a magnet. These magnets are fixed to the core by filling the housing holes with plastic. The magnets are fixed to the core by using, for example, a rotor manufacturing apparatus disclosed in Japanese Laid-Open Patent Publication No. 2015-192575.

When manufacturing a rotor using the manufacturing apparatus, the core is arranged together with a support plate between a first die and a second die, which are opened in the apparatus. The support plate is used to support the core. The core supported by the support plate contacts a surface of the support plate on one side in a thickness direction. The support plate is arranged between the first die and the second die such that the surface of the support plate on a side opposite to the core in the thickness direction contacts the first die.

A gate plate is arranged between the first die and the second die in an opened state. Specifically, the gate plate is arranged between the core and the second die. The gate plate is used to form a passage for injecting plastic into the housing holes of the core. When the first die and the second die are clamped, plastic is injected from a nozzle into the housing holes, which accommodate the magnets, through the passage formed by the gate plate and the second die. In this manner, the magnets are fixed to the core with the plastic injected into the housing holes, so that the rotor is manufactured.

The plastic for fixing the magnets to the core may be a thermosetting plastic or a thermoplastic. Thermoplastics have a higher viscosity when melted than thermosetting plastics. Thus, when a thermoplastic is used as the plastic for fixing the magnets to the core, the injection pressure of the plastic tends to be higher than when a thermosetting plastic is used. The manufacturing apparatus disclosed in Japanese Laid-Open Patent Publication No. 2015-192575 employs slide core blocks to prevent the core from being deformed even if the injection pressure is increased due to the use of a thermoplastic.

The slide core blocks are provided between the first die and the second die. The slide core blocks are arranged at prescribed intervals in the circumferential direction of the core. Each slide core block is movable in a radial direction of the core. The slide core blocks are moved toward the center of the core when the first core and the second core are clamped, so as to restrain the core so that the core is not deformed in a direction in which the diameter is increased when the plastic is injected. In addition, the slide core blocks are heated to limit decreases in the temperature of the plastic injected into the housing holes of the core.

If a thermoplastic is used as the plastic for fixing the magnets to the core, slide core blocks need to be provided as in the rotor manufacturing apparatus disclosed in Japanese Laid-Open Patent Publication No. 2015-192575 in order to limit deformation of the core caused by injection of plastic. As a result, the slide core blocks complicate the structure of the rotor manufacturing apparatus.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method for manufacturing a rotor is provided. The method includes: arranging a core including a housing hole in which a magnet is configured to be accommodated such that the core contacts a surface of a support plate on one side in a thickness direction; arranging the support plate, which contacts the core, between a first die and a second die in an opened state such that a surface of the support plate that is opposite to the core contacts the first die, and arranging a gate plate between the core and the second die; when the first die and the second die are clamped, injecting, from a nozzle, a thermoplastic into the housing hole, which accommodates the magnet, through a passage formed by the second die and the gate plate, wherein, with the first die heated, the thermoplastic is injected from the nozzle into the housing hole through the passage; and fixing the magnet to the core with the thermoplastic injected into the housing hole.

Other features and aspects will be apparent from the following detailed description, the drawings, and the claims.

### BRIEF DESCRIPTION OF THE DRAWINGS

FIG. 1 is a perspective view showing a rotor.

FIG. 2 is a cross-sectional view of the rotor shown in FIG. 1.

FIG. 3 is a cross-sectional view showing an apparatus for manufacturing the rotor shown in FIG. 1.

FIG. 4 is a cross-sectional view illustrating a state in which a tab is crushed.

FIG. 5 is a cross-sectional view illustrating a state in which a core is placed on a first die.

FIG. 6 is a cross-sectional view illustrating a state in which the core is pressed by a second die.

FIG. 7A is a cross-sectional view illustrating a state before the core is pressed by the second die.

FIG. 7B is a cross-sectional view illustrating a state after the core is pressed by the second die.

FIG. 8 is a cross-sectional view illustrating a state in which plastic is injected into housing holes.

FIG. 9 is a cross-sectional view a support plate according to a modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, except for operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

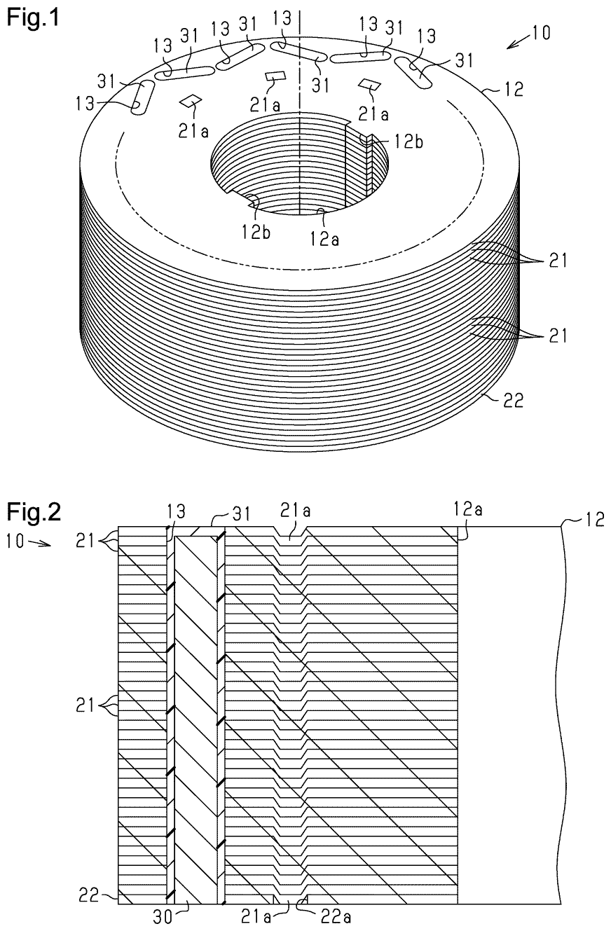

A method for manufacturing a rotor according to one embodiment will now be described with reference to FIGS. 1 to 8.

### Structure of Rotor

As shown in FIGS. 1 and 2, a rotor 10 of an interior permanent magnet motor includes a core 12. The core 12 has a structure achieved by stacking iron core pieces, which are disc-shaped magnetic steel sheets, in a thickness direction. Specifically, the core 12 is formed by stacking first iron core pieces 21 and a second iron core piece 22 in the thickness direction. Accordingly, the iron core pieces of the core 12 include the first iron core pieces 21 and the second iron core piece 22. In the core 12, the first iron core pieces 21 are stacked in the thickness direction. The second iron core piece 22 is in contact with an end of the first iron core pieces 21 in the stacking direction, that is, the lowest one of the first iron core pieces 21 as viewed in FIG. 2. In other words, the second iron core piece 22 is located adjacent to the first iron core piece 21 at one end in the stacking direction of the first iron core pieces 21.

Each first iron core piece 21 includes tabs 21a that bulge toward one side in a thickness direction of the first iron core piece 21, more specifically, toward the second iron core piece 22. When the first iron core pieces 21 are stacked in the thickness direction, the tabs 21a of the first iron core pieces 21 overlap each other in the thickness direction. The stacked first iron core pieces 21 are coupled together by press-fitting the tabs 21a into each other. The second iron core piece 22 includes through-holes 22a at positions that correspond to the tabs 21a of the first iron core pieces 21. The tabs 21a are inserted into the through-holes 22a. The tabs 21a of the first iron core piece 21 adjacent to the second iron core piece 22 are fitted into the through-holes 22a of the second iron core pieces 22. This couples the second iron core piece 22 to the adjacent first iron core piece 21. In addition, the through-holes 22a of the second iron core piece 22 prevent the protruding ends of the tabs 21a of the lowest one of the first iron core pieces 21 from protruding from the end face in the direction of the center line of the core 12.

The core 12 has a center hole 12a. The center hole 12a extends along the center line of the core 12. The center hole 12a has two protrusions 12b on the inner circumferential surface. The two protrusions 12b protrude so as to be opposed to each other from the inner circumferential surface of the center hole 12a. The two protrusions 12b extend in the same direction as the center line of the core 12. The center hole 12a receives the shaft of the interior permanent magnet motor. When the shaft is inserted into the center hole 12a, the protrusions 12b are fitted into keyways formed in the outer circumferential surface of the shaft. This restricts the rotation of the shaft relative to the core 12 about the center line.

The core 12 has housing holes 13 on the outer side of the center hole 12a. The housing holes 13 extend in parallel with the center hole 12a through the core 12. The housing holes 13 are arranged around the center line of the core 12 to surround the center line. As shown in FIG. 2, each housing hole 13 accommodates a magnet 30. Each magnet 30 has an elongated shape extending along the center line of the core 12. Each magnet 30 has a substantially rectangular cross section orthogonal to its longitudinal direction. The housing holes 13, which accommodate the magnets 30, are filled with plastic 31, so that the magnets 30 are fixed to the core 12. The plastic 31 is a thermoplastic such as a liquid-crystal polymer.

The plastic 31 in each housing hole 13 is located between the outer surface of the magnet 30 and the inner surface of the housing hole 13. The length of each magnet 30 is less than the stacking height of the core 12. The stacking height of the core 12 refers to the height of the core 12 in the stacking direction of the iron core pieces. The end face of each magnet 30 on one side in the longitudinal direction is located on the same plane as the end face of the core 12 in the stacking direction of the iron core pieces. Specifically, the lower end face of the magnet 30 shown in FIG. 2 is located on the same plane as the lower end face of the core 12. The end face of each magnet 30 on the other side in the longitudinal direction is located closer to the core piece at the center of the core 12 than the corresponding end face of the core 12 in the stacking direction of the core pieces. In other words, the upper end face of each magnet 30 shown in FIG. 2 is closer to the core piece at the center of the core 12 than the upper end face of the core 12 is. The upper end face of each magnet 30 in the longitudinal direction is covered by the plastic 31.

### Rotor Manufacturing Apparatus

A rotor manufacturing apparatus for manufacturing the rotor 10 by filling the housing holes 13 of the core 12 with the plastic 31 will now be described.

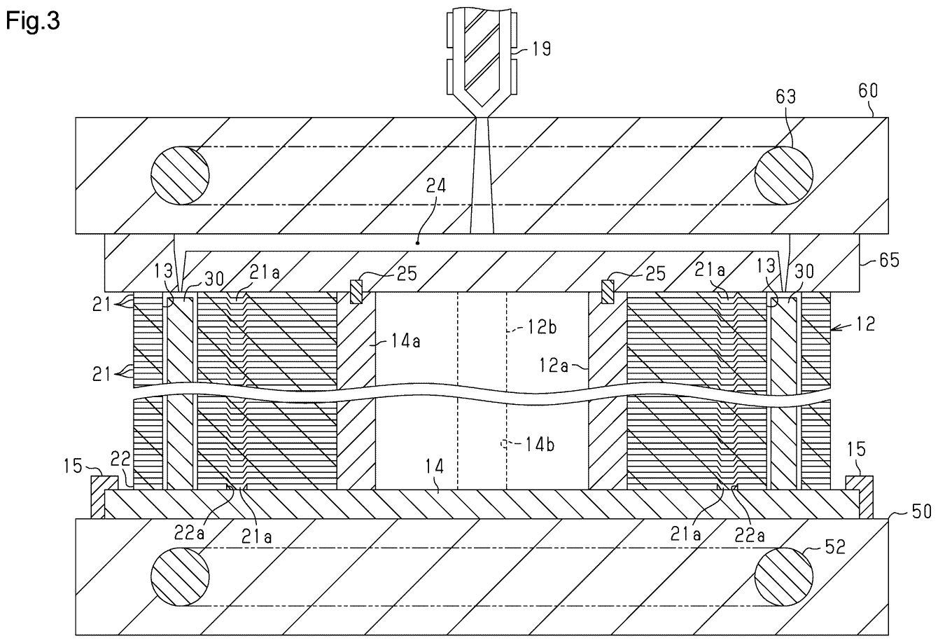

As shown in FIG. 3, the rotor manufacturing apparatus includes a first die 50, a second die 60, and a gate plate 65. The first die 50 and the second die 60 approach each other when clamped as shown in FIG. 3, and are separated from each other when opened. In the rotor manufacturing apparatus, the first die 50 and the second die 60 are alternately opened and clamped. The first die 50 incorporates a first heater 52, which generates heat when energized. The second die 60 incorporates a second heater 63, which generates heat when energized. Also, the second die 60 is provided with a nozzle 19 that injects the plastic 31 in a molten state (FIG. 2).

When the first die 50 and the second die 60 are opened, the core 12 is arranged between the first die 50 and the second die 60 before the housing holes 13 are filled with the plastic 31. Specifically, the core 12, having the magnets 30 accommodated in the housing holes 13, is arranged between the first die 50 and the second die 60 together with the support plate 14. The support plate 14 supports the core 12 by contacting one end face of the core 12 in the stacking direction of the iron core pieces, that is, the lower end face of the core 12 shown in FIG. 3. The support plate 14 is configured to transport the core 12 into the space between the first die 50 and the second die 60 in an opened state and to transport the core 12 from the space between the first die 50 and the second die 60.

A cylindrical post 14a is fixed to the support plate 14. The post 14a extends in a direction orthogonal to the support plate 14. The post 14a is arranged to extend through the center hole 12a of the core 12 when the core 12 is conveyed by the support plate 14. The post 14a has grooves 14b in the outer circumferential surface. The grooves 14b extend in the center line of the post 14a. The protrusions 12b of the core 12 can be inserted into the grooves 14b. By inserting the protrusions 12b of the core 12 into the grooves 14b of the post 14a, the position of the core 12 is fixed with respect to the post 14a in the circumferential direction.

When the first die 50 and the second die 60 are opened, the support plate 14, which supports the core 12, is moved to the space between the first die 50 and the second die 60. Further, the support plate 14 is arranged such that the surface opposite to the core 12 contacts the first die 50. The first die 50 includes positioning members 15, which determine the position of the support plate 14 at a predetermined position in the first die 50. Since the position of the support plate 14 is determined with respect to the first die 50, the position of the core 12, which is supported by the support plate 14, is fixed with respect to the first die 50.

The gate plate 65 is arranged between the first die 50 and the second die 60. When the first die 50 and the second die 60 are clamped, the gate plate 65 forms a passage 24 through which the plastic 31 injected from the nozzle 19 flows into the housing holes 13 of the core 12. The gate plate 65 is conveyed integrally with the core 12 to the space between the first die 50 and the second die 60, so as to be arranged between the core 12 and the second die 60. The gate plate 65 may be arranged between the core 12 and the second die 60 after the core 12 is conveyed to the space between the first die 50 and the second die 60.

The gate plate 65, which is arranged between the core 12 and the second die 60, contacts the end face of the core 12 on the side opposite to the support plate 14. The position of the gate plate 65 in the circumferential direction in relation to the post 14a of the support plate 14 is fixed by pins 25. When the first die 50 and the second die 60 are clamped, the gate plate 65 and the second die 60 form the passage 24. The opening of the passage 24 on the side facing the core 12 is connected to the housing holes 13 of the core 12. In this state, the plastic 31 in a molten state is injected from the nozzle 19. Accordingly, the plastic 31 flows through the passage 24 to fill the housing holes 13 of the core 12. The plastic 31 filling the housing holes 13 decreases in temperature and hardens. This fixes the magnets 30 accommodated in the housing holes 13 to the core 12.

Thereafter, the first die 50 and the second die 60 are opened. The gate plate 65, which is in contact with the core 12, can be detached from the core 12 and the post 14a when the first die 50 and the second die 60 are opened. Also, the detachment of the gate plate 65 from the core 12 and the post 14a may be performed after the core 12 and the support plate 14 are conveyed from the space between the first die 50 and the second die 60. After being detached from the core 12 and the post 14a, the gate plate 65 is reused after removing the plastic 31 that has hardened outside of the accommodating holes 13 of the core 12.

The gate plate 65 may be attached to the second die 60. In this case, when the first die 50 and the second die 60 are opened, the gate plate 65 is separated from the core 12. When the first die 50 and the second die 60 are clamped, the gate plate 65 contacts the core 12, which is arranged between the first die 50 and the second die 60. At this time, the gate plate 65 and the second die 60 form the passage 24. The plastic 31 is injected into the housing holes 13 of the core 12 through the passage 24. Thereafter, when the first die 50 and the second die 60 are opened, the gate plate 65 is separated from the core 12. At this time, the plastic 31 that has hardened in the passage 24 outside of the housing holes 13 is removed from the gate plate 65.

Next, a method for manufacturing a rotor will be described, with each step of the manufacturing method being described separately. These steps include a crushing step, a pressing step, and an injection step.

### Crushing Step

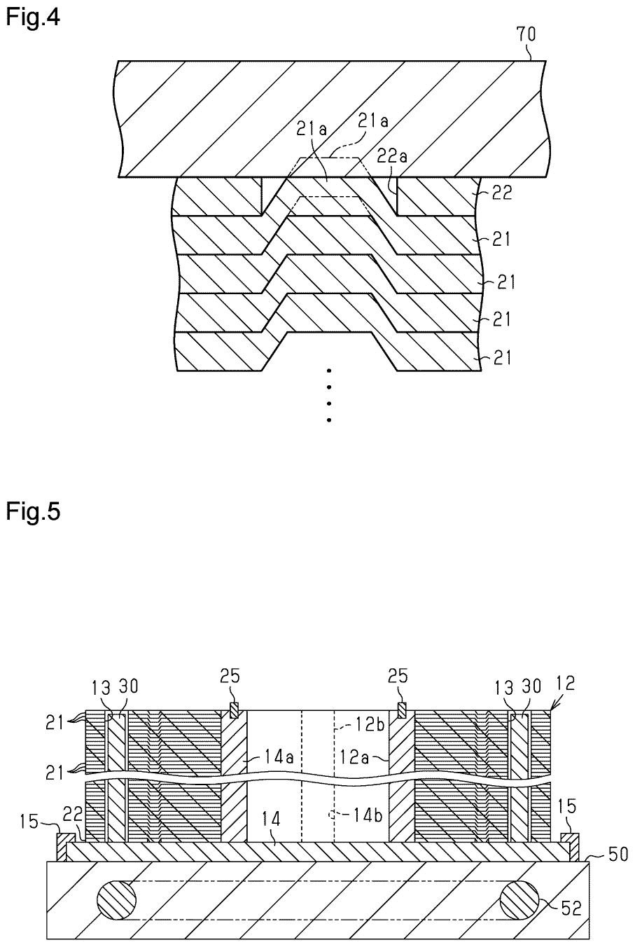

When the first iron core pieces 21 and the second iron core piece 22 of the core 12 are joined together, the protruding ends of the tabs 21a of the first iron core piece 21 adjacent to the second iron core piece 22 may protrude outward from the through-holes 22a of the second iron core piece 22. The long-dash double-short-dash line in FIG. 4 represents the position of the protruding end of the tab 21a in this case. In this step, the protruding end of the tab 21a is pressed by a pressing jig 70. This crushes the protruding end so that it is contained in the through-hole 22a.

After the crushing step is performed, the support plate 14 conveys the core 12 to the space between the first die 50 and the second die 60. Specifically, the core 12 is supported on the support plate 14 shown in, for example, FIG. 5. At this time, the post 14a extends through the center hole 12a of the core 12, and the second iron core piece 22 of the core 12 is arranged to contact a surface the support plate 14 on one side in the thickness direction, that is, the upper surface of the support plate 14 shown in FIG. 5. As a result, the openings of the housing holes 13 of the core 12 on the side corresponding to the support plate 14 are closed by the support plate 14. In this state, the support plate 14 is conveyed to the space between the first die 50 and the second die 60.

When the core 12 is supported on the support plate 14, the core 12 may be inverted vertically from the position shown in FIG. 5. That is, the core 12 may be arranged with respect to the support plate 14 such that, when the post 14a is inserted through the center hole 12a of the core 12, the second iron core piece 22 is located at the end of the core 12 on the opposite side to the support plate 14. In this case, the openings of the housing holes 13 of the core 12 on the side corresponding to the support plate 14 are also inverted from those in the case shown in FIG. 5. Even in a state in which the openings of the accommodating holes 13 are closed by the support plate 14, the support plate 14 is conveyed to the space between the first die 50 and the second die 60.

As shown in FIG. 5, the support plate 14 is arranged such that a surface of the support plate 14 that is on a side opposite to the core 12 in the thickness direction contacts the first die 50. At this time, the support plate 14 is placed at a predetermined position in the first die 50 by the positioning members 15. When the support plate 14 is arranged to be in contact with the first die 50 as described above, the magnets 30 are accommodated in the housing holes 13 of the core 12. The magnets 30 contact the support plate 14.

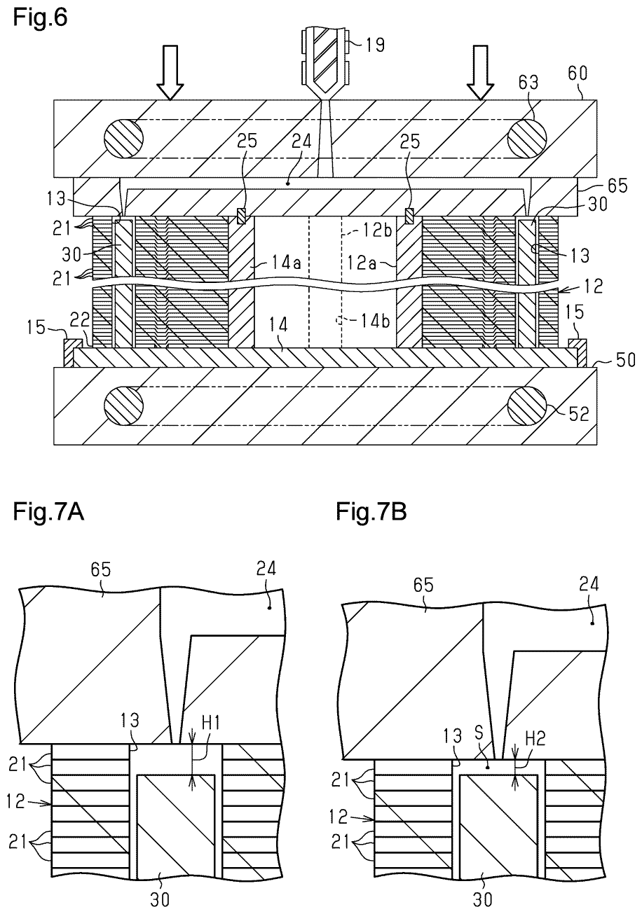

Thereafter, as shown in FIG. 6, the first die 50 and the second die 60 are clamped with the gate plate 65 arranged between the core 12 and the second die 60. At this time, the gate plate 65 contacts the end face of the core 12 that is opposite to the support plate 14, and the passage 24, which is formed by the gate plate 65 and the second die 60, is connected to the housing holes 13.

### Pressing Step

In this step, as the first die 50 and the second die 60 are clamped, the core 12 is pressed toward the first die 50, that is, toward the support plate 14, by the second die 60 through the gate plate 65. As the core 12 is pressed toward the support plate 14, gaps between the iron core pieces of the core 12 are eliminated, so that the iron core pieces are in close contact with each other. As a result, the stacking height of the core 12 is reduced.

As the stacking height of the core 12 decreases, the end face of the core 12 moves downward as shown in FIGS. 7A and 7B. As a result, a distance H1 from the end face of the core 12 shown in FIG. 7A to the magnet 30 located below the end face of the core 12 is reduced to a distance H2 shown in FIG. 7B. Accordingly, a space S corresponding to the distance H2 is created between the magnet 30 and the gate plate 65, which is in contact with the end face of the core 12. That is, the core 12 is pressed by the second die 60 through the gate plate 65 such that the space S is created.

### Injection Step

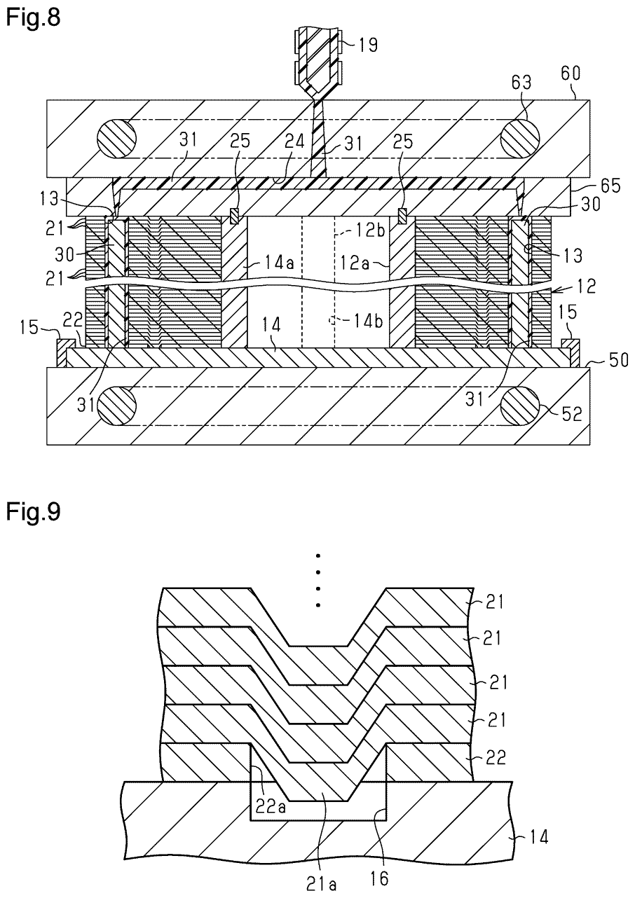

In this step, after the first die 50 and the second die 60 are clamped in the pressing step, the plastic 31 is injected from the nozzle 19 into the housing holes 13 of the core 12 through the passages 24 as shown in FIG. 8. The plastic 31 is injected while the core 12 is pressed toward the support plate 14 through the gate plate 65 by the second die 60 in the pressing step. Thus, the plastic 31 that has passed through the passage 24 is injected into the housing holes 13 of the core 12 through the space S shown in FIG. 7B. In this manner, the housing holes 13 are filled with the plastic 31 as shown in FIG. 8.

When the plastic 31 filling the housing holes 13 decreases in temperature and hardens, the plastic 31 fixes the magnets 30 to the core 12. When the first die 50 and the second die 60 are opened after the magnets 30 are fixed to the core 12, the support plate 14 is moved from the space between the first die 50 and the second die 60. Accordingly, the core 12 is conveyed from the space between the first die 50 and the second die 60 by the support plate 14.

### Setting of Pressing Force Acting on Core 12 at Clamping

If the pressing force produced when the core 12 is pressed toward the support plate 14 by the second die 60 through the gate plate 65 is relatively small in the pressing step, the plastic 31 in the housing holes 13 may leak from the gap between the iron core pieces of the core 12 in the injection step. If the pressing force is relatively large, the springback of each iron core piece may create gaps between the iron core pieces when the second die 60 stops pressing the core 12 through the gate plate 65 after the plastic 31 in the housing holes 13 hardens. To avoid these problems, the pressing force that acts on the core 12 in the pressing step is set to a value at which the plastic 31 does not leak out through gaps between the core pieces from the housing holes 13, and at which the springback does not create gaps between the core pieces.

### Heating of First Die 50 and Second Die 60

In the injection step, the plastic 31 is injected from the nozzle 19 into the housing holes 13 of the core 12 through the passages 24 in a state in which the first die 50 and the second die 60 are heated. The first die 50 is heated by energizing the first heater 52. The heat of the first die 50 is transferred to the core 12 through the support plate 14. The second die 60 is heated by energizing the second heater 63. The heat of the second die 60 is transferred to the core 12 through the gate plate 65. The heating temperature of the first die 50 and the heating temperature of the second die 60 may be set, for example, to be lower than or equal to the glass transition temperature of the plastic 31. The heating of the first die 50 and the second die 60 may be performed before the plastic 31 is injected in the injection step or during the injection of the plastic 31.

Operation and advantages of the method for manufacturing a rotor according to the present embodiment will now be described.

(1) In the injection step, the plastic 31 is injected from the nozzle 19 into the housing holes 13 of the core 12 through the passage 24, which is formed by the gate plate 65 and the second die 60, in a state in which the first die 50 is heated. Since the plastic 31 injected into the housing holes 13 flows from the second die 60 toward the first die 50, the temperature of the plastic 31 tends to decrease toward the first die 50. However, the heat of the first die 50, which has been heated, is transferred to the core 12 through the support plate 14, and is further transferred to the plastic 31 in the housing holes 13. The heat transfer from the first die 50 limits reduction in the temperature of the plastic 31 in the housing holes 13. This limits an increase in the viscosity of the plastic 31, which would occur if the temperature of the plastic 31 decreased. Also, this limits deformation of the core 12, which would be caused by an increase in the injection pressure of the plastic 31 if the viscosity increased. Therefore, it is not necessary to provide the rotor manufacturing apparatus with a mechanism such as a slide core block for preventing deformation of the core 12. As a result, the structure of the rotor manufacturing apparatus is not complicated.

(2) In the injection step, not only the first die 50, but also the second die 60 is heated. Accordingly, when the plastic 31 passes through the passage 24, which is formed by the gate plate 65 and the second die 60, the temperature of the plastic 31 is unlikely to decrease. As a result, the temperature of the plastic 31 injected into the housing holes 13 of the core 12 from the passage 24 is unlikely to decrease. This further limits an increase in the injection pressure of the plastic 31.

(3) In the pressing step and the injection step, the second die 60 presses the core 12 toward the support plate 14 through the gate plate 65. This increases the contact are a between the core 12 and the support plate 14 and reduces the air layer between the core 12 and the support plate 14. As a result, the heat of the first die 50 is readily transferred to the core 12 through the support plate 14. When the core 12 is pressed toward the support plate 14 by the second die 60 through the gate plate 65, the contact area between the gate plate 65 and the core 12 is increased, and the air layer between the gate plate 65 and the core 12 are reduced. The heating of the second die 60 allows the heat of the second die 60 to be readily transferred to the core 12 through the gate plate 65.

(4) In the injection step, the core 12 is pressed by the second die 60 through the gate plate 65, so that gaps between the stacked iron core pieces in the core 12 are eliminated. Thus, when the plastic 31 is injected into the housing holes 13 of the core 12, the plastic 31 in the housing holes 13 is prevented from leaking through the gaps. In addition, even if the stacking height of the core 12 decreases as the core 12 is pressed, the space S is ensured between the gate plate 65 and each magnet 30 in the stacking direction of the iron core pieces as shown in FIG. 7B. If the space S is not ensured, the passage 24 for injecting the plastic 31 into the housing holes 13 may be closed by the magnets 30 as the gate plate 65 contacts the magnets 30. However, since the space S is ensured, the passage 24 is prevented from being closed by the magnets 30, so that the housing holes 13 are readily filled with the plastic 31.

(5) The second iron core piece 22 is located at an end of the core 12 in the stacking direction of the iron core pieces. When the tabs 21a of the first iron core piece 21 protrude from the through-holes 22a of the second iron core piece 22, the protruding ends of the tabs 21a contact the support plate 14 when the first die 50 and the second die 60 are clamped. As a result, a gap may be created between the core 12 and the support plate 14. In a case in which the core 12 is inverted from the state shown in FIG. 5 and is supported on the support plate 14, the protruding ends of the tabs 21a contact the gate plate 65 when the first die 50 and the second die 60 are clamped. This may create gaps between the core 12 and the gate plate 65. In these cases, the plastic 31 injected into the housing holes 13 of the core 12 in the injection process leaks through the gaps. However, since the protruding ends of the tabs 21a are crushed such that the protruding ends are located inside the through-holes 22a in the crushing step before the injection step, such gaps are not created. Thus, the plastic 31 injected into the housing holes 13 of the core 12 in the injection process is prevented from leaking through gaps. Also, when gaps are created between the core 12 and the support plate 14, the contact area between the core 12 and the support plate 14 is reduced, so that the heat of the first die 50 is not readily transferred to the core 12 through the support plate 14. The difficulty in heat transfer to the core 12 due to these factors is also mitigated by the crushing of the protruding ends of the tabs 21a.

(6) By moving the support plate 14, which supports the core 12, to the space between the first die 50 and the second die 60 in an opened state, the core 12 is conveyed to the space between the first die 50 and the second die 60. Also, by moving the support plate 14, which supports the core 12, from the space between the first die 50 and the second die 60, the core 12 is conveyed from the space between the first die 50 and the second die 60. Therefore, the core 12 is readily conveyed to the space between the first die 50 and the second die 60, and from the space between the first die 50 and the second die 60, by the movement of the support plate 14, which supports the core 12.

(7) When the surface of the support plate 14 on the side opposite to the core 12 is arranged to contact the first die 50 between the first die 50 and the second die 60 in an opened state, the position of the support plate 14 is determined with respect to the first die 50. At this time, the position of the core 12 relative to the support plate 14 about the center of the post 14a is fixed. This allows the first die 50 and the second die 60 to be clamped with the core 12 positioned at a fixed position with respect to the first die 50.

The above-described embodiment may be modified as follows. The above-described embodiment and the following modifications can be combined as long as the combined modifications remain technically consistent with each other.

As shown in FIG. 9, the support plate 14 may include accommodating recesses 16 at positions that correspond to the through-holes 22a of the core 12. In this case, the tabs 21a of the first iron core piece 21 in the core 12 can be accommodated in the accommodating recesses 16 of the support plate 14. It is thus possible to omit the above-described crushing step.

Even if the protruding ends of the tabs 21a of the first iron core piece 21 adjacent to the second iron core piece 22 of the core 12 protrude from the through-holes 22a of the second iron core piece 22 as indicated by the long-dash double-short-dash line in FIG. 4, the protruding ends of the tabs 21a are accommodated in the accommodating recess 16 when the core 12 is supported by the support plate 14. As a result, the protruding ends of the tabs 21a are prevented from contacting the support plate 14. In the injection step, the accommodating recesses 16 in the support plate 14 accommodate the protruding ends of the tabs 21a, which protrude from the through-holes 22a of the second iron core piece 22, and the support plate 14, which supports the core 12, is arranged to be in contact with the first die 50.

If the protruding ends of the tabs 21a are in contact with the support plate 14 in the injection step, a gap may be created between the support plate 14 and the core 12 when the first die 50 and the second die 60 are clamped. In this case, the plastic 31 injected into the housing holes 13 of the core 12 in the injection process leaks through the gap. The structure shown in FIG. 9 prevents such leakage of the plastic 31.

The core 12 may be formed by stacking multiple core piece blocks, which are each formed by stacking multiple first iron core pieces 21 and one second iron core piece 22. In this case, the core piece blocks are fixed to each other by, for example, the plastic 31.

The first iron core pieces 21 do not necessarily need to be joined to each other by press-fitting the tabs 21a into each other, but may be joined to each other by, for example, the plastic 31.

In the pressing step, the space S does not necessarily need to be created between the second die 60 and each magnet 30. In this case, the position of the openings of the passage 24 on the side corresponding to the core 12 are set to positions where the magnets 30 are not provided in the housing holes 13.

The pressing step does not necessarily need to be performed before the injection step.

The heating temperature of the first die 50 and the heating temperature of the second die 60 do not necessarily need to be the same, but the heating temperature of the first die 50 may be higher than the heating temperature of the second die 60. In this case, since the temperature gradient in the stacking direction of the housing holes 13 decreases, the temperature of the plastic 31 injected into the housing holes 13 is unlikely to decrease.

The second die 60 does not necessarily need to be heated. In this case, the plastic 31 remaining in the passage 24 after the injection step hardens at an early stage. This allows the gate plate 65 to be separated from the rotor 10 at an early stage after the injection process.

In the injection step, the plastic 31 may be injected immediately after the heating of the first die 50 and the second die 60 is stopped. That is, if the core 12 is sufficiently heated immediately before the plastic 31 is injected, the heating of the first die 50 and the second die 60 may be stopped before the plastic 31 is injected.

The core 12 may be preheated prior to the injection step.

Cooling passages through which coolant flows are formed in the first die 50 and the second die 60. After the injection process, coolant may be supplied to the cooling passages of the first die 50 and the second die 60, so that the core 12 is cooled by using the first die 50 and the second die 60. In this case, the plastic 31 in the core 12 hardens quickly after the injection step.

The plastic 31 is not limited to a liquid crystal polymer and may be, for example, polyphenylene sulfide (PPS), polyetherether ketone (PEEK), or polyamide (PA) such as nylon 66.

The support plate 14 does not necessarily need to convey the core 12.

The post 14a may be omitted from the support plate 14.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A method for manufacturing a rotor, comprising:
arranging a core including a housing hole in which a magnet is configured to be accommodated such that the core contacts a surface of a support plate on one side in a thickness direction;
arranging the support plate, which contacts the core, between a first die and a second die in an opened state such that a surface of the support plate that is opposite to the core contacts the first die, and arranging a gate plate between the core and the second die;
when the first die and the second die are clamped, injecting, from a nozzle, a thermoplastic into the housing hole, which accommodates the magnet, through a passage formed by the second die and the gate plate, wherein, with the first die heated, the thermoplastic is injected from the nozzle into the housing hole through the passage; and
fixing the magnet to the core with the thermoplastic injected into the housing hole.

2. The method for manufacturing the rotor according to claim 1, wherein, with the second die heated, the thermoplastic is injected from the nozzle into the housing hole through the passage.

3. The method for manufacturing the rotor according to claim 1, wherein
the core is formed by stacking iron core pieces in a thickness direction,
before the injection, the core is pressed toward the support plate through the gate plate by the second die, and
with the core being pressed toward the support plate through the gate plate by the second die, the thermoplastic is injected from the nozzle into the housing hole through the passage.

4. The method for manufacturing the rotor according to claim 3, wherein
when a height of the core in a stacking direction of the iron core pieces is defined as a stacking height, a length of the magnet in the stacking direction of the iron core pieces is less than the stacking height of the core, and
in the injection, the pressing is performed such that a space is created between the gate plate and the magnet in the stacking direction while causing the iron core pieces to be in close contact with each other and reducing the stacking height of the core.

5. The method for manufacturing the rotor according to claim 1, wherein
the core is formed by stacking iron core pieces in a thickness direction,
the iron core pieces include first iron core pieces and a second iron core piece,
the first iron core pieces each include a tab protruding on one side in a thickness direction, the first iron core pieces being stacked in the thickness direction with the tabs coupled to each other,
the second iron core piece is located adjacent to one of the first iron core pieces at an end in the stacking direction of the stacked first iron core pieces,
the second iron core piece includes a through-hole into which the tab of the first iron core piece located adjacent to the second iron core piece is inserted, and
before the injection, a protruding end of the tab protruding from the through-hole is crushed so that the protruding end is located inside the through-hole.

6. The method for manufacturing the rotor according to claim 1, wherein
the core is formed by stacking iron core pieces in a thickness direction,
the iron core pieces include first iron core pieces and a second iron core piece,
the first iron core pieces each include a tab protruding on one side in a thickness direction, the first iron core pieces being stacked in the thickness direction with the tabs coupled to each other,
the second iron core piece is located adjacent to one of the first iron core pieces at an end in the stacking direction of the stacked first iron core pieces,
the second iron core piece includes a through-hole into which the tab of the first iron core piece located adjacent to the second iron core piece is inserted, and
in the injection, a protruding end of the tab protruding from the through-hole of the second iron core piece is accommodated in an accommodating recess in the support plate, while the core is caused to contact the support plate.

7. The method for manufacturing the rotor according to claim 1, wherein the support plate is configured to convey the core by, while supporting the core, moving to a space between the first die and the second die in an opened state and moving from the space between the first die and the second die in the opened state.

8. The method for manufacturing the rotor according to claim 1, wherein
a post is fixed to the support plate, the post extending through the core in contact with a surface of the support plate on one side in the thickness direction,
the support plate is configured to be positioned with respect to the first die when arranged such that the surface that is opposite to the core in the thickness direction is in contact with the first die, and
the post is configured to fix a position of the core relative to the support plate about a center of the post.
